(19) United States
(12) Patent Application Publication
(10) Pub. No.: US 2024/0348757 A1
(43) Pub. Date: Oct. 17, 2024

(54) IMAGING GUIDE DEVICE

(71) Applicant: NEC Corporation, Minato-ku, Tokyo (JP)

(72) Inventors: Kazuhiro WATANABE, Tokyo (JP); Rui ISHIYAMA, Tokyo (JP)

(73) Assignee: NEC Corporation, Minato-ku, Tokyo (JP)

(21) Appl. No.: 18/294,210

(22) PCT Filed: Aug. 19, 2021
(86) PCT No.: PCT/JP2021/030462

§ 371 Date: Feb. 1, 2024

(51) Int. Cl. H04N 9/31

(52) U.S. Cl. CPC H04N 9/3185; H04N 9/3194

(57) ABSTRACT

An imaging guide device includes a computation means for computing a plane projection transformation matrix of a first image obtained by capturing a flat surface of an object with a first imaging device and a second image obtained by capturing the flat surface with a second imaging device; an acquisition means for acquiring a second figure obtained by transforming a first figure on the basis of the plane projection transformation matrix, the first figure being virtually drawn on the first image in a predetermined direction and a predetermined shape; a generation means for generating a tilt index representing a tilt in an imaging direction of the second imaging device with respect to the first imaging device on the basis of the second figure, and generating a display item including the tilt index; and a display control means for displaying the display item in a superimposed manner on the second image.

### TECHNICAL FIELD

The present invention relates to an imaging guide device, an imaging guide method, and a storage medium.

### BACKGROUND ART

An attempt to use an individual difference between images, obtained by capturing an object with a camera, for individual authentication or matching has been performed (for example, see Patent Literature 1).

In the case of using an individual difference between images of an object captured with a camera for individual authentication or the like, when the direction of the camera at the time of capturing an object subject to registration and the direction of the camera at the time of capturing an object subject to matching differ from each other, authentication performance is deteriorated due to an influence of projection distortion (also referred to as trapezoid distortion). Therefore, it is important to match direction of the camera at the time of registration and that at the time of matching.

As literatures describing art related to the present invention, Patent Literature 2 and Patent Literature 3 have been known.

In the art described in Patent Literature 2 (hereinafter referred to as first related art), when imaging a matching area of an object subject to matching with a camera at the time of matching, a registration image that is an image of a matching area previously captured with a camera set in a predetermined direction at a predetermined position or the contour line thereof (hereinafter simply referred to as a registration image) is displayed in a superimposed manner on a through image (also referred to as a preview image or a live view image).

The art disclosed in Patent Literature 3 (hereafter referred to as second related art) is art to assist fixed point observation in which an inspection point of a structure such as a bridge is imaged with a camera at the same position and direction each time. In the second related art, for a candidate image of a structure captured with a camera, a plane projection transformation matrix (also referred to as homography matrix) of a registration image of the same structure captured in the past with a camera set in a predetermined direction at a predetermined position is estimated. Then, in the second related art, a synthetic image created by synthesizing an image after transforming the registration image on the basis of the estimated plane projection transformation matrix and the candidate image is displayed on a display device.

### CITATION LIST

### Patent Literature

Patent Literature 1: JP 6217886 B
Patent Literature 2: JP 6206645 B
Patent Literature 3: WO 2020/145004 A

### SUMMARY OF INVENTION

### Technical Problem

According to the first related art, by adjusting the direction of the camera such that a matching area of a through image matches a registration image, a user can make the direction of the camera at the time of registration and that at the time of matching coincide with each other. However, at first sight of the matching area of the through image and the registration image, the user cannot easily determine to which direction the camera should be adjusted to allow the matching area of the thorough image and the registration image to coincide with each other. Of course, if the original shape of the matching area is known, it is logically possible to estimate the adjustment direction of the camera direction from the direction of the projection distortion in the shape of the matching area of the through image and the direction of the projection distortion in the shape of the registration image that is displayed on the through image in a superimposed manner. However, there is a case where the original shape of the matching area is unknown. Moreover, even though it is known, there is a case where the shape is not a simple shape such as a rectangle but a shape in which the adjustment direction of the direction of the camera is difficult to be estimated from the direction of the projection distortion such as a trapezoid, a rhombus, or a star shape. Due to such reasons, in the first related art, it is not easy to adjust the direction of the camera at the time of matching so as to coincide with the direction at the time of registration.

Meanwhile, consideration will be given on applying the second related art in the field of fixed point observation to imaging for individual authentication. A configuration in that case is estimating a plane projection transformation matrix of an image of a matching area of an object subject to matching captured with a camera at the time of matching and a registration image of the matching area previously captured with a camera set in a predetermined direction and position, and displaying, on the display device, a synthetic image generated by synthesizing the image after transforming the registration image on the basis of the plane projection transformation matrix and an image of the matching area of the object subject to matching. According to such a configuration, a user determines the direction to adjust the camera direction on the basis of the shape of the image after transforming the registration image on the basis of the plane projection transformation matrix and the original shape of the matching area. However, there is a case where the original shape of the matching area is unknown, as described above. Moreover, even though it is known, there is a case where the shape is not a simple shape such as a rectangle but a shape in which the adjustment direction of the camera direction is difficult to be estimated from the direction of the projection distortion such as a trapezoid, a rhombus, or a star shape. Due to such reasons, in the case of applying the second related art to imaging for individual authentication, it is not easy to adjust the camera direction at the time of matching to coincide with the direction at the time of registration.

An object of the present invention is to provide an imaging guide device that solves the above-described problem.

### Solution to Problem

An imaging guide device, according to one aspect of the present invention, is configured to include
a computation means for computing a plane projection transformation matrix of a first image and a second image, the first image being obtained by capturing a flat surface of an object with a first imaging device, the second image being obtained by capturing the flat surface with a second imaging device;
an acquisition means for acquiring a second figure that is obtained by transforming a first figure on the basis of the plane projection transformation matrix, the first figure being virtually drawn on the first image in a predetermined direction and in a predetermined shape;
a generation means for generating a tilt index representing a tilt in an imaging direction of the second imaging device with respect to the first imaging device on the basis of the second figure, and generating a display item including the tilt index; and
a display control means for displaying the display item in a superimposed manner on the second image.

An imaging guide method, according to another aspect of the present invention, is configured to:
compute a plane projection transformation matrix of a first image and a second image, the first image being obtained by capturing a flat surface of an object with a first imaging device, the second image being obtained by capturing the flat surface with a second imaging device;
acquire a second figure that is obtained by transforming a first figure on the basis of the plane projection transformation matrix, the first figure being virtually drawn on the first image in a predetermined direction and in a predetermined shape;
generate a tilt index representing a tilt in an imaging direction of the second imaging device with respect to the first imaging device on the basis of the second figure, and generate a display item including the tilt index; and
display the display item in a superimposed manner on the second image.

A computer-readable medium, according to another aspect of the present invention, is configured to storing thereon a program for causing a computer to execute processing to
compute a plane projection transformation matrix of a first image and a second image, the first image being obtained by capturing a flat surface of an object with a first imaging device, the second image being obtained by capturing the flat surface with a second imaging device;
acquire a second figure that is obtained by transforming a first figure on the basis of the plane projection transformation matrix, the first figure being virtually drawn on the first image in a predetermined direction and in a predetermined shape;
generate a tilt index representing a tilt in an imaging direction of the second imaging device with respect to the first imaging device on the basis of the second figure, and generate a display item including the tilt index; and
display the display item in a superimposed manner on the second image.

### Advantageous Effects of Invention

Since the present invention has the configurations as described above, a user can easily determine how to adjust the direction the camera so as to make the camera direction at the time of matching coincide with the direction at the time of registration, from the direction of the projection distortion of the figure in a predetermined shape.

### BRIEF DESCRIPTION OF DRAWINGS

FIG. 1 is a block diagram of an individual identification system according to a first example embodiment of the present invention.

FIG. 2 is a schematic diagram illustrating an example of a relative positional relation between a camera and a product at the time of imaging the product in a first step processing device of a production line constituting the individual identification system according to the first example embodiment of the present invention.

FIG. 3 illustrates an example of a registration image captured in the first step processing device of the production line constituting the individual identification system according to the first example embodiment of the present invention.

FIG. 4 is a schematic diagram illustrating an example of a relative positional relation between a camera and a product at the time of imaging the product in a second step processing device of the production line constituting the individual identification system according to the first example embodiment of the present invention.

FIG. 5 illustrates an example of a matching image captured in the second step processing device of the production line constituting the individual identification system according to the first example embodiment of the present invention.

FIG. 6 illustrates another example of a matching image captured in the second step processing device of the production line constituting the individual identification system according to the first example embodiment of the present invention.

FIG. 7 is a block diagram of an individual identification device according to the first example embodiment of the present invention.

FIG. 8 is a diagram illustrating an example of a guide image presented to a user by the individual identification device according to the first example embodiment of the present invention.

FIG. 9 is a diagram illustrating a configuration example of a product DB in the individual identification device according to the first example embodiment of the present invention.

FIG. 10 is a flowchart illustrating an example of an operation performed by an imaging guide unit in the individual identification device according to the first example embodiment of the present invention.

FIG. 11 is a flowchart showing an example of detailed processing of step S5.

FIG. 12 illustrates an example of a reference image in which a reference figure is drawn.

FIG. 13 is a flowchart illustrating an example of a process of computing a fourth index.

FIG. 14 illustrates examples of a reference figure and a figure subjected to projection transformation, a figure in which the projection distortion is exaggerated, and a figure subjected to rotation.

FIG. 15 is a flowchart illustrating an example of a process of coloring each side of a figure according to projection distortion.

FIG. 16 is a flowchart illustrating an example of an operation performed by a registration unit of the individual identification device according to the first example embodiment of the present invention.

FIG. 17 is a flowchart illustrating an example of an operation performed by a matching unit of the individual identification device according to the first example embodiment of the present invention.

FIG. 18 is a flowchart illustrating an example of a process of matching between a matching image and a registration image performed by the matching unit of the individual identification device according to the first example embodiment of the present invention.

FIG. 19 is a block diagram illustrating an imaging guide device according to a second example embodiment of the present invention.

### DESCRIPTION OF EMBODIMENTS

Next, an embodiment of the present invention will be described in detail with reference to the drawings.

### First Example Embodiment

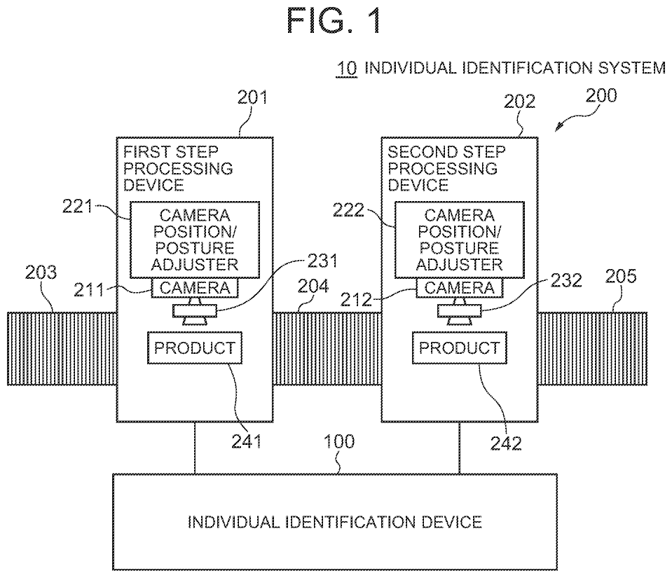

FIG. 1 is a block diagram of an individual identification system 10 to which an imaging guide device, according to a first example embodiment of the present invention, is applied. The individual identification system 10 includes an individual identification device 100 and a production line 200.

The production line 200 is a line for producing industrial products. The industrial products to be produced are not limited particularly. For example, industrial products may be electric products such as printed wiring boards, metal products such as screws and washers, food products such as canned beer, and pharmaceutical products such as medicines. The production line 200 is configured to include at least two step processing devices, namely a first step processing device 201 and a second step processing device 202, and conveying machines 203 to 205 such as conveyers. For example, in the case of a surface mount technology (SMT) line for printed wiring boards, the first step processing device 201 is a solder printer that applies solder onto substrates for example, and the second step processing device 202 is a component mounter that mount a plurality of electronic components on predetermined locations of substrates after the solder printing. Alternatively, the first step processing device 201 may be a component mounter, and the second step processing device 202 may be a reflow device that allows a substrate to flow in a thermostatic bath to melt and fix solder in order to fix the mounted components on the substrate. The conveying machines 203 to 205 are means for conveying products from the upstream side to the downstream side one by one, in the order of the first step processing device 201 and the second step processing device 202.

The production line 200 includes at least two phases namely an adjustment phase and an operation phase. The adjustment phase is performed prior to the operation phase. In the adjustment phase, processes such as adjustment of position and posture of a camera, to be described below, are performed. In the operation phase, a process of producing a large amount of products in an assembly-line system is performed. In the operation phase, the products having passed through the first step processing device 201 are then carried into the second step processing device 202. However, between the first step processing device 201 and the second step processing device 202, a buffer part in which products are temporarily accumulated in random order may be provided. Therefore, the products having passed through the first step processing device 201 do not always pass through the second step processing device 202 while keeping the passing order. Therefore, individual identification is performed to identify that a product carried to the second step processing device 202 is identical to which product having passed through the first step processing device 201.

The individual identification device 100 is an information processing device that manages individuals of products produced in the production line 200, for manufacturing step management, quality management, shipping management, sales management, and the like. The individual identification device 100, the first step processing device 201, and the second step processing device 202 are connected communicably with one another in a wired or wireless manner. The first step processing device 201 and the second step processing device 202 are provided with cameras 211 and 212 for imaging products 241 and 242 carried into the first step processing device 201 and the second step processing device 202 for individual identification, camera position/posture adjusters 221 and 222 for adjusting positions and posture of the cameras 211 and 212, and illumination units 231 and 232 for irradiating products with light for imaging. Each of the cameras 211 and 212 may be a visible-light color camera or a black-and-white camera equipped with a charge-coupled device (CCD) image sensor or a complementary MOS (CMOS) image sensor having a pixel capacity of about several millions pixels, for example. Each of the camera position/posture adjusters 221 and 222 may be a pan tilt platform or a 6-axis robot arm, for example. Each of the illumination units 231 and 232 may be a ring illumination unit or a dome illumination unit, for example.

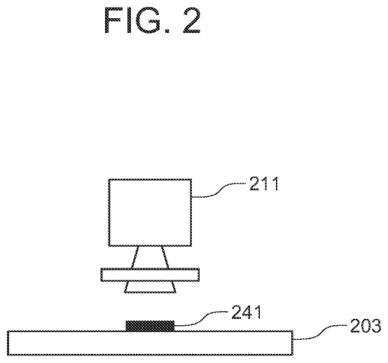

FIG. 2 is a schematic diagram illustrating an example of a relative positional relation between the camera 211 and the product 241 at the time of imaging the product in the first step processing device 201. The camera 211 is placed at a position where an upper surface of the product 241 can be imaged from above. The position of the camera 211 is adjustable in the left and right direction on the sheet, the front and back direction of the sheet, and the up and down direction of the sheet by the camera position/posture adjuster 221. The posture of the camera 211 is adjustable in the left and right direction (pan direction), the up and down direction (tilt direction), and the camera turn direction (roll direction) by the camera position/posture adjuster 221. When the product 241 is carried into the first step processing device 201 by the conveying machine 203, at the point of time when the tip of the product 241 reaches a predetermined position, conveyance is temporarily stopped and the product 241 is in a stationary state. The user adjusts the position and posture of the camera 211 by the camera position/posture adjuster 221 so as to allow a random pattern formed on the upper surface of the product 241 in a stationary state to be captured as a light-dark pattern. At that time, optimum position and posture of the camera 211 may be determined by using tools such as a level, a sensor, or the like as needed. Then, upon completion of adjustment by the camera position/posture adjuster 221, the user fixes the camera at the position and the posture. The camera 211 acquires a registration image that is an image in which a matching area of the product 241 in a stationary state is captured, in the state of the fixed position and posture.

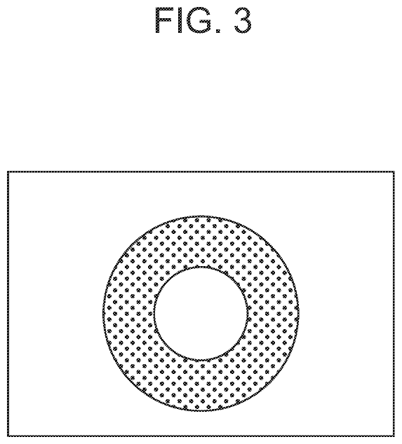

FIG. 3 illustrates an example of a registration image obtained by capturing a matching area of the product 241 with the camera 211. The product 241 of this example is a washer made of metal and having a ring shape in a planer view. The matching area is the entire upper surface of the product 241. The upper surface of the product 241 forms a substantially identical flat surface. In general, on the surfaces of a plurality of products 241 manufactured through the same manufacturing process, there are fine patterns unique to each of the respective products 241, and fine patterns and non-fine patterns common to a plurality of products 241.

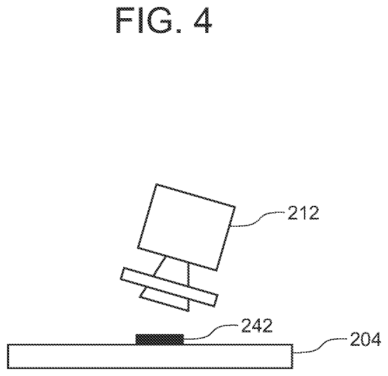

Meanwhile, FIG. 4 is a schematic diagram illustrating an example of a relative positional relation between the camera 212 and the product 242 at the time of imaging the product in the second step processing device 202. The camera 212 is placed at a position where an upper surface of the product 242 can be imaged from above. The position of the camera 212 is adjustable in the left and right direction on the sheet, the front and back direction of the sheet, and the up and down direction of the sheet by the camera position/posture adjuster 222. The posture of the camera 212 is adjustable in the left and right direction (pan direction), the up and down direction (tilt direction), and the camera turn direction (roll direction) by the camera position/posture adjuster 222. When the product 242 is carried into the second step processing device 202 by the conveying machine 204, at the point of time when the tip of the product 242 reaches a predetermined position, conveyance is temporarily stopped and the product 242 is in a stationary state. The camera 212 images an upper surface of the product 242 in a stationary state from above. At that time, the user initializes the position and the posture of the camera 212 by the camera position/posture adjuster 222 such that the position and the posture of the camera 212 with respect to the product 242 becomes the same as the position and the posture of the camera 211 with respect to the product 241.

However, due to various factors such as erroneous setting of a camera position performed manually or an individual difference in the camera position adjuster, the initialized position and posture of the camera 212 with respect to the product 242 in the second step processing device 202 may be different from the position and posture of the camera 211 with respect to the product 241 in the first step processing device 201. For example, in order to set the position of the camera 212 to the same position as that of the camera 211, even when the camera position/posture adjuster 222 is provided with the movement amount that is the same as the movement amount given to the camera position/posture adjuster 221, the camera may not be set to the same position actually due to the individual difference between the camera position/posture adjusters 221 and 222. Further, in order to set the posture of the camera 212 to the same posture as that of the camera 211, even when the camera position/posture adjuster 222 is provided with the rotation amount that is the same as the rotation amount given to the camera position/posture adjuster 221, the camera may not be set to the same rotation amount actually due to the individual difference between the camera position/posture adjusters 221 and 222.

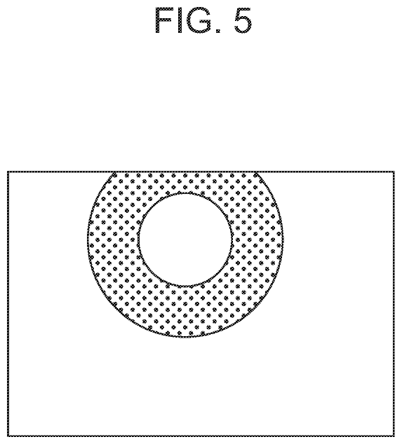

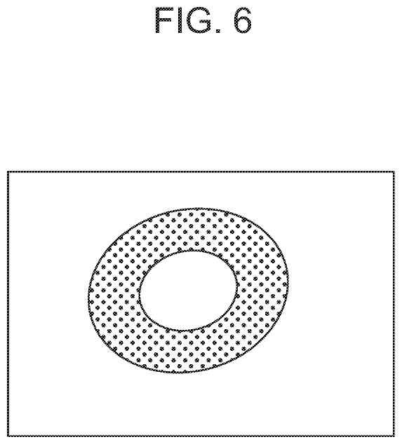

When the position and posture of the camera 212 differ from those of the camera 211, even though the entire upper surface of the product 241 is contained in the image in the camera 211, the entire upper surface of the product 242 may not be contained in the image in the camera 212 and a part thereof may be cut, as illustrated in FIG. 5 for example. Moreover, when the position and posture of the camera 212 differ from those of the camera 211, even though no projection distortion is generated in the image of the upper surface of the product 241 in the camera 211, projection distortion may be generated in the image of the upper surface of the product 242 in the camera 212, as illustrated in FIG. 6 for example. A positional shift by which the entire matching area is not contained in the image as illustrated in FIG. 5 can be visually recognized according to the position of the product on the image. Therefore, the user can cope with it relatively easily. However, it is difficult to visually check the difference in the camera posture as illustrated in FIG. 6 when the posture difference is 10 degrees or less. Moreover, small projection distortion that causes an image difference of several pixels or so becomes a factor of deteriorating the matching performance. Therefore, it is important to assist the user so as to allow the user to adjust the position and posture of the camera 212 so as not to cause a difference in the camera posture that brings about projection distortion particularly. Therefore, the individual identification device 100 is configured to present, to the user, information showing the difference of the position and posture of the camera 212 with respect to the position and posture of the camera 211. Hereinafter, the individual identification device 100 will be described in detail.

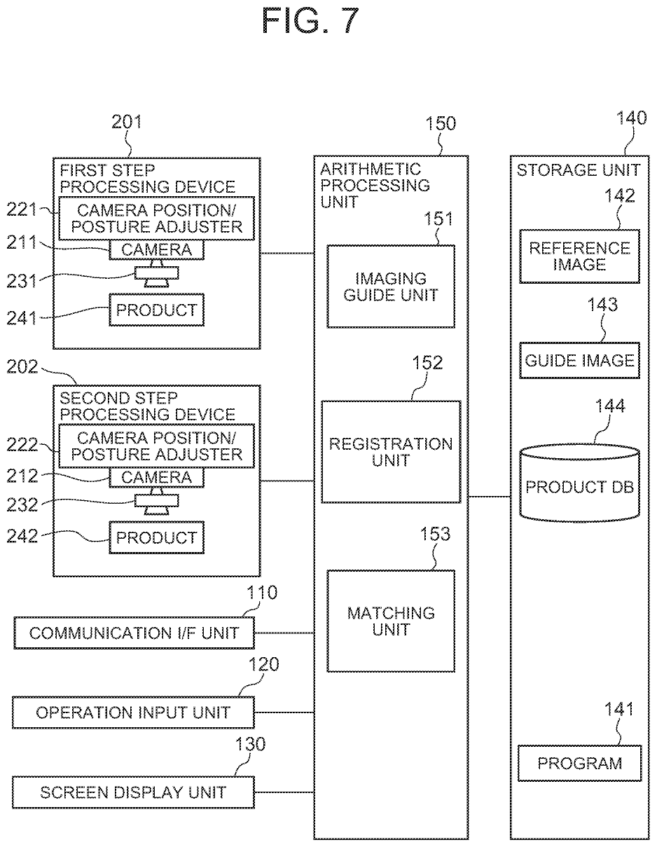

FIG. 7 is a block diagram of the individual identification device 100. Referring to FIG. 7, the individual identification device 100 is communicably connected with the first step processing device 201 and the second step processing device 202. The individual identification device 100 is also configured to include a communication interface (IF) unit 110, an operation input unit 120, a screen display unit 130, a storage unit 140, and an arithmetic processing unit 150.

The communication IF unit 110 is configured of a data communication circuit, and is configured to perform data communication with an external device in a wireless or wired manner. The operation input unit 120 is configured of devices such as a keyboard and a mouse, and is configured to detect operation by an operator and output it to the arithmetic processing unit 150. The screen display unit 130 is configured of a device such as a liquid crystal display (LCD), and is configured to display various types of information on a screen according to an instruction from the arithmetic processing unit 150.

The storage unit 140 is configured of storage devices such as a hard disk and a memory, and is configured to store therein processing information and a program 141 necessary for various types of processing in the arithmetic processing unit 150. The program 141 is a program for implementing various processing units by being read and executed by the arithmetic processing unit 150, and is read in advance from an external device or a storage medium via a data input-output function of the communication I/F unit 110 and is stored in the storage unit 140. Main processing information stored in the storage unit 140 includes a reference image 142, a guide image 143, and a product database (DB) 144.

The reference image 142 is an image of a matching area of a product for position/posture adjustment (hereinafter referred to as a reference product) carried into the first step processing device 201, and is captured with the camera 211 whose position and posture have been adjusted. The reference product is one of a plurality of products produced on the production line 200. The reference product may be applied with predetermined steps in the first step processing device 201 and the second step processing device 202 as same as the other products produced on the production line 200, or those steps may be omitted. For example, in the case of a washer made of metal having a ring shape in a plan view, an example of the reference image 142 becomes the same image as an example of the registration image illustrated in FIG. 3.

The guide image 143 is an image in which a display item representing the degree of a shift in the position and posture of the camera 212 with respect to the camera 211 is superimposed on an image, captured with the camera 212, of the matching area of the reference product carried into the second step processing device 202.

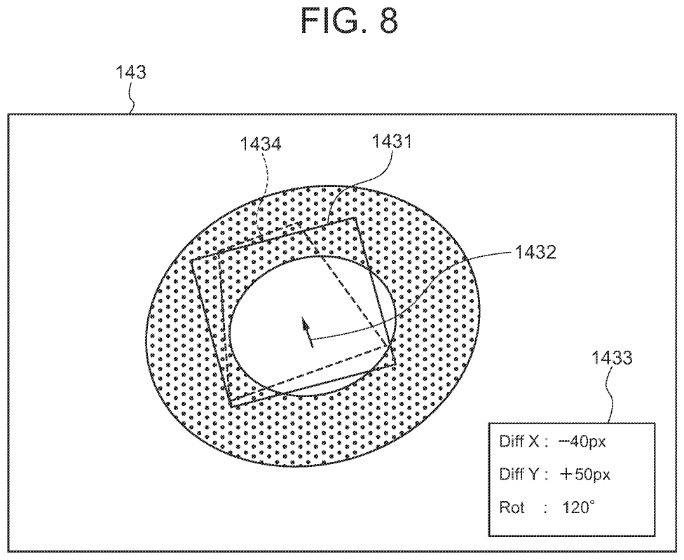

FIG. 8 illustrates an example of the guide image 143. In the guide image 143 of this example, a display item including a first index 1431, a second index 1432, a third index 1433, and a fourth index 1434 is superimposed on an image captured with the camera 212. The first index 1431 is also referred to as a non-tilt index. The second index 1432 is also referred to as an arrow index. The third index 1433 is also referred to as a text index. The fourth index 1434 is also referred to as a tilt index.

The first index 1431 is configured of a square figure, and represents a positional shift and a rotational shift of the camera 212 with respect to the camera 211, by the position and direction of the square. For example, when there is no rotational shift in the camera 212, the square is drawn in an upright state. On the contrary, when there is a rotational shift in the camera 212, the square is drawn in a rotated state from the upright state according to the amount of the rotational shift. The second index 1432 is configured of an arrow, and represents a positional shift and a rotational shift of the camera 212 with respect to the camera 211, by the length and direction of the arrow. For example, when there is no positional shift in the camera 212, the length of the arrow is zero and the arrow is not drawn substantially. On the contrary, when there is a positional shift in the camera 212, an arrow having a length corresponding the amount of positional shift is drawn. At that time, the tip of the arrow is drawn at a position that is the same as the center of the square constituting the first index 1431. Accordingly, when there is a positional shift in the camera 212, the square constituting the first index 1431 is drawn to be shifted by the length and direction of the arrow. The third index 1433 is configured of text including three rows. The first row and the second row represent the positional shift in the X-axis direction and the Y-axis direction of the camera 212 with respect to the camera 211, and the third row represents the rotational shift angle of the camera 212 with respect to the camera 211. As described above, all of the first index 1431, the second index 1432, and the third index 1433 represent the positional shift and the rotational shift of the camera 212 with respect to the camera 211.

The fourth index 1434 is configured of a quadrangular figure, and represents a tilt in the imaging direction of the camera 212 with respect to the camera 211. When there is no tilt shift in the imaging direction of the camera 212 with respect to the camera 211, the quadrangle constituting the fourth index 1434 is drawn as a square in which each side is colored with a first color (for example, green). On the contrary, when there is a tilt shift in the imaging direction of the camera 212 with respect to the camera 211, the quadrangle is drawn as a trapezoid having projection distortion in the direction according to the direction of the tilt shift. Moreover, among the four sides of the trapezoid, a side having the same length as the opposing side is colored with a first color (for example, green), a side having a shorter length than the opposing side is colored with a second color (for example, red), and a side having a longer length than the opposing side is colored with a third color (for example, blue).

However, the indexes constituting the display item of the guide image 143 are not limited to those described above. For example, the display item may include only the fourth index 1434. Alternatively, the display item may include the fourth index 1434 and one or two of the first to third indexes. Alternatively, the display item may include another item that is different from the first to fourth indexes. As an example of another index, an index configured of an arrow indicating the direction of projection distortion of the fourth index 1434 may be considered.

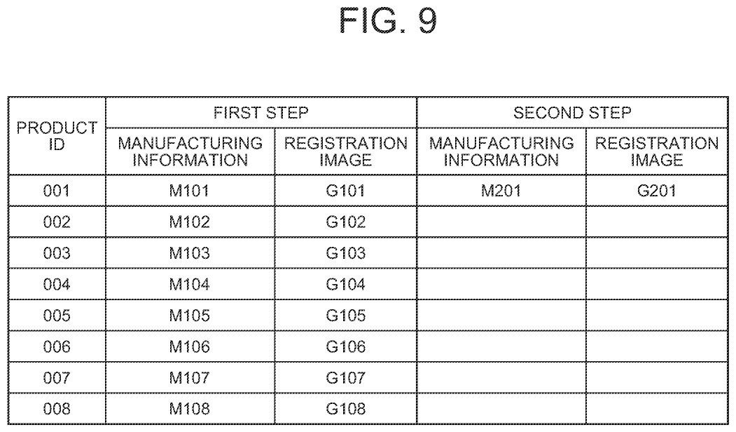

The product DB 144 is a database for storing information such as images of products that are mass-produced on the production line 200. FIG. 9 illustrates an example of a configuration of the product DB 144. The product DB 144 of this example is configured of a plurality of entries, and one entry is configured of fields for product ID, manufacturing information and registration images of the first step, and manufacturing information and matching images of the second step. In the product ID field, an ID such as a serial number assigned to each product is set. In the fields of manufacturing information and a registration image of the first step, manufacturing information including the work history of the product in the first step, the form of components used, lot number, and the like, and a registration image that is an image of the product captured with the camera 211, are set. In the fields of manufacturing information and a matching image of the second step, manufacturing information including the work history of the product in the second step, the form of components used, lot number, and the like, and a matching image that is an image of the product captured with the camera 212, are set.

The arithmetic processing unit 150 has a processor such as an MPU and the peripheral circuits thereof, and is configured to read and execute the program 141 from the storage unit 140 to allow the hardware and the program 141 to cooperate with each other to thereby implement various processing units. The main processing units to be implemented by the arithmetic processing unit 150 include an imaging guide unit 151, a registration unit 152, and a matching unit 153.

The imaging guide unit 151 is configured to assist work of adjusting positions and posture of the cameras 211 and 212 by a user in the adjustment phase of the production line 200. For example, the imaging guide unit 151 is configured to present, to the user, information showing the difference in the position and posture of the camera 212 with respect to the position and posture of the camera 211, via the screen display unit 130.

The registration unit 152 is configured to acquire an image of a product carried into the first step processing device 201 in the operation phase of the production line 200, and stores a registration image and the like in the product DB 144.

The matching unit 153 is configured to, in the operation phase phase of the production line 200, acquire an image of a product carried into the second step processing device 202, and performs matching against a registration image of a product having passed through the first step processing device 201 stored in the product DB 144, to thereby perform individual identification to identify which of the products having passed through the first step processing device 201 the product carried into the second step processing device 202 is.

Next, operation of the individual identification device 100 will be described. First, operation in the adjustment phase of the individual identification device 100 will be described.

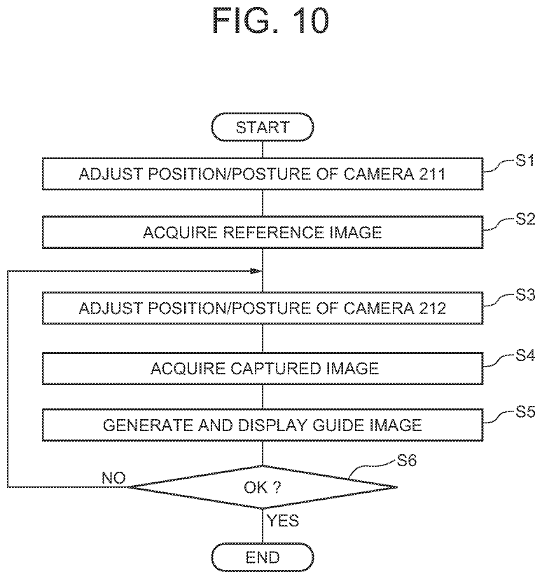

FIG. 10 is flowchart illustrating an example of processing performed by the imaging guide unit 151 in the adjustment phase. Referring to FIG. 10, first, the imaging guide unit 151 adjusts the position and posture of the camera 211 by the camera position/posture adjuster 221, in accordance with an instruction input from the user via the operation input unit 120 (step S1). Since the optimum matching area of a product differs depending on the type of the product, the user adjusts it by inputting the position/posture information of the camera 211 corresponding to the type of the product to be manufactured from the operation input unit 120. Here, it is assumed that the camera 211 is adjusted and fixed at a position and posture such that the entire upper surface of the product 241 is contained in an image from above as described with reference to FIG. 3, in accordance with the position and posture information input from the user.

Upon completion of adjustment of the position and posture of the camera 211, the user places a reference product on the conveying machine 203, and allows it to be conveyed toward the first step processing device 201. When the reference product is carried into the first step processing device 201, it is detected by a sensor, not illustrated, provided in the first step processing device 201, and at the point of time when the reference product reaches a predetermined position, conveyance is temporarily stopped and the reference product is in a stationary state. Further, the fact that the product has been carried in the first step processing device 201 is notified from the first step processing device 201 to the individual identification device 100 via communication. When the imaging guide unit 151 detects that the reference product has been carried in by the communication, the imaging guide unit 151 acquires an image of the reference product with the camera 211 as the reference image 142, and stores it in the storage unit 140 (step S2). At that time, the imaging guide unit 151 may display the reference image 142 on the screen display unit 130 so as to allow the user to confirm it.

In this way, by the operation of the imaging guide unit 151, the position and the posture of the camera 211 in the first step processing device 201 on the production line 200 are adjusted, and the reference image 142 that is an image of the reference product, captured under the adjusted position and posture of the camera 211, is stored in the storage unit 140.

Then, the imaging guide unit 151 adjusts the position and the posture of the camera 212 by the camera position/posture adjuster 222, in accordance with an instruction input from the user via the operation input unit 120 (step S3). At the time of first position/posture adjustment of the camera 212, for example, the user may perform adjustment by inputting position and posture information that allows the camera 212 to be the same position and posture as those of the adjusted camera 211, from the operation input unit 120.

After adjustment of the position and the posture of the camera 212, the user takes out the reference product carried into the first step processing device 201 from the first step processing device 201, places it on the conveying machine 204, and allows it to be conveyed toward the second step processing device 202. When the reference product is carried into the second step processing device 202 by the conveying machine 204, it is detected by a sensor, not illustrated, provided in the second step processing device 202, and at the point of time when the reference product reaches a predetermined position, conveyance is temporarily stopped and the reference product is in a stationary state. Further, the fact that the product has been carried into the second step processing device 202 is notified from the second step processing device 202 to the individual identification device 100 via communication. When the imaging guide unit 151 detects that the reference product has been carried in, the imaging guide unit 151 captures an image of the reference product with the camera 212 and acquires the captured image (step S4).

Then, the imaging guide unit 151 generates the guide image 143 as illustrated in FIG. 8 from the reference image 142 acquired at step S2 and the captured image (hereinafter referred to as a captured image SG) acquired at step S4 that is a previous step, and displays it on the screen display unit 130 (step S5). The user visually confirms the displayed guide image 143, and checks whether or not the position and the posture of the camera 212 are not shifted with respect to the camera 211. Then, when there is no need to readjust the position and the posture of the camera 212, for example, the user inputs an instruction indicating OK from the operation input unit 120, otherwise, the user inputs an instruction indicating NG. When an instruction indicating OK is input, the imaging guide unit 151 ends the processing illustrated in FIG. 10. On the contrary, when an instruction indicating NG is input, the imaging guide unit 151 returns to the processing of step S3 and repeats the same processing as that described above.

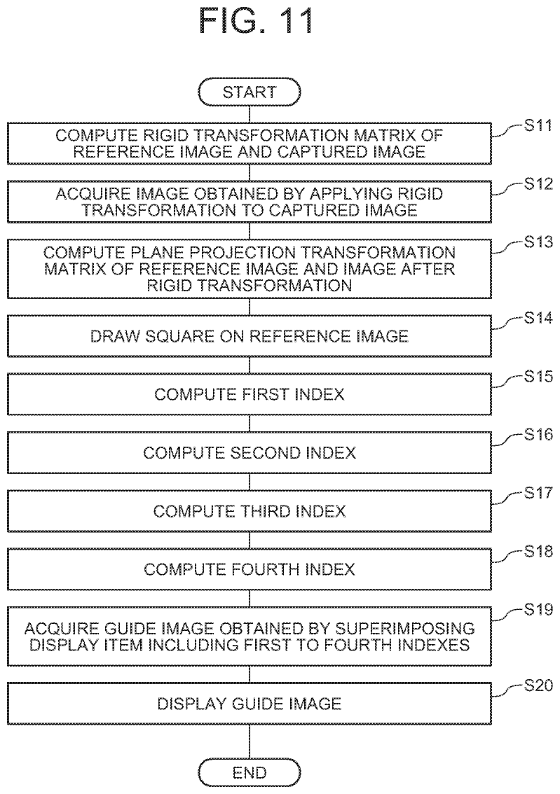

Next, the details of step S5 to generate the guide image 143 will be described. FIG. 11 is a flowchart illustrating an example of detailed processing of step S5.

First, the imaging guide unit 151 computes a plane projection transformation matrix Mh of the reference image 142 acquired at step S2 and the captured image SG acquired at previous step S4 (step S11 to S12). Specifically, the imaging guide unit 151 first computes a rigid transformation matrix Mr of the reference image 142 and the captured image SG (step S11). The reference image 142 and the captured image SG are images of the same reference product. On a surface of the reference product, there are fine patterns unique to an individual of the product, and there are also fine patterns and non-fine patterns common to a plurality of products due to the product mold. Therefore, in the reference image 142 and the captured image SG, there are identical light-dark patterns caused by the identical fine patterns and non-fine patterns. The imaging guide unit 151 computes the rigid transformation matrix Mr of the reference image 142 and the captured image SG on the basis of such identical light-dark patterns. For example, the imaging guide unit 151 computes the rigid transformation matrix Mr by using a phase only correlation method. Specifically, the imaging guide unit 151 first performs FFT transformation on each of the reference image 142 and the captured image SG, and then further performs logarithm polar coordinate transformation. Then, from the frequency spectrum images of the reference image 142 and the captured image SG after the logarithm polar coordinate transformation, the imaging guide unit 151 computes the rotation angle and the amount of expansion/contraction between the reference image 142 and the captured image SG by using the phase only correlation. Then, by using the computed rotation angle and the amount of expansion/contraction, the imaging guide unit 151 corrects the rotational shift and an expansion/contraction shift in the reference image 142 and the captured image SG, and then, from the frequency spectrum images of the reference image 142 and the captured image SG after the correction, the imaging guide unit 151 computes the positional shift amount (parallel movement amount) between the reference image 142 and the captured image SG by using the phase only correlation. The rigid transformation matrix Mr is determined uniquely from the computed positional shift amount, the rotation angle, and the expansion/contraction amount.

Then, the imaging guide unit 151 acquires an image (hereinafter referred to as a captured image SG′) obtained by applying rigid transformation to the captured image SG by using the computed rigid transformation matrix Mr (step S12). The captured image SG′ becomes an image substantially overlapping the reference image 142. Then, from the reference image 142 and the captured image SG′, the imaging guide unit 151 computes a plane projection transformation matrix Mh′ between the two images (step S13). Specifically, first, the imaging guide unit 151 extracts a plurality of feature points from each of the reference image 142 and the captured image SG′ by using an arbitrary method such as SIFT, Random, or the like. Then, the imaging guide unit 151 associates the feature points with each other between the reference image 142 and the captured image SG′ by using Lucas-Kanade method. Then, the imaging guide unit 151 computes the plane projection transformation matrix Mh′ of the reference image 142 and the captured image SG′ by using the coordinates of the associated feature point groups.

The plane projection transformation matrix Mh of the reference image 142 and the captured image SG is given by a product of the rigid transformation matrix Mr and the plane projection transformation matrix Mh′. Note that the plane projection transformation matrix Mh can be dissolved into a similarity transformation matrix, an affine transformation matrix, and a projection transformation matrix. Therefore, transformation of parallel movement, rotation, and expansion/contraction using the rigid transformation matrix Mr is the same as transformation of parallel movement, rotation, and expansion/contraction using the similarity transformation matrix and the affine transformation matrix obtained by dissolving the plane projection transformation matrix Mh. Moreover, transformation using the plane projection transformation matrix Mh′ is the same as transformation using the projection transformation matrix obtained by dissolving the plane projection transformation matrix Mh.

In the above description, the plane projection transformation matrix Mh of the reference image 142 and the captured image SG is computed by dividing it into the rigid transformation matrix Mr of the reference image 142 and the captured image SG and the plane projection transformation matrix Mh′ of the reference image 142 and the captured image SG′ after the transformation by the rigid transformation matrix Mr. However, the method of computing the plane projection transformation matrix Mh is not limited to that described above. For example, in the environment where it is ensured that a rotational shift, a positional shift, and an expansion/contraction shift between the reference image 142 and the captured image SG are small, the plane projection transformation matrix Mh may be computed directly from the reference image 142 and the captured image SG. That is, the imaging guide unit 151 first extracts a plurality of feature points from each of the reference image 142 and the captured image SG by using an arbitrary method such as SIFT, Random, or the like. Then, the imaging guide unit 151 associates the feature points with each other between the reference image 142 and the captured image SG by using Lucas-Kanade method. Then, the imaging guide unit 151 computes the plane projection transformation matrix Mh of the reference image 142 and the captured image SG by using the coordinates of the associated feature point groups.

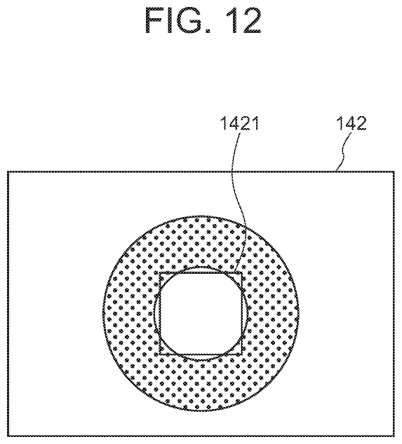

Then, the imaging guide unit 151 virtually draws a reference FIG. 1421 having a predetermined direction and a predetermined shape, on a flat surface of the reference product in the reference image 142 (step S14). FIG. 12 illustrates an example of the reference image 142 in which the reference FIG. 1421 is drawn. The reference FIG. 1421 of this example is a square. Further, in this example, the reference FIG. 1421 is drawn in an upright direction in such a manner that the center thereof coincides with the center of the reference product. The upright direction is a direction in which each side of the reference FIG. 1421 is parallel to the horizontal direction (X axis) or the vertical direction (Y axis) of the reference image 142. The position of each vertex of the reference FIG. 1421 is specified by the XY coordinate values of the reference image 142. However, the reference FIG. 1421 is not limited to a square, and may be a figure having another shape such as a rectangle. Moreover, the upright direction of the reference FIG. 1421 is not limited to that described above.

Then, the imaging guide unit 151 computes a first index 1431 configured of a square that represents a positional shift and a rotational shift by the position and the direction thereof, by applying rigid transformation by the rigid transformation matrix Mr computed at step S11 with respect to the reference FIG. 1421 (step S15). Further, the size of the square constituting the first index 1431 is determined by the size of the reference FIG. 1421 and the expansion/contraction components of the rigid transformation matrix Mr. In order to visualize the amount of expansion/contraction shift of the camera 212, it is possible to create a square with no amount of expansion/contraction shift as one index and include it in the display item.

Then, the imaging guide unit 151 computes a second index 1432 that represents a positional shift and a rotational shift by the length and the direction of an arrow, from the positional shift amount and the rotation angle that are components of the rigid transformation matrix Mr computed at step S11 (step S16).

Then, the imaging guide unit 151 computes a third index 1433 that represents a positional shift and a rotational shift by the text, from the positional shift amount and the rotation angle that are components of the rigid transformation matrix Mr computed at step S11 (step S17).

Then, the imaging guide unit 151 computes a fourth index 1434 (step S18). The details of step S18 will be described in detail later. Then, the imaging guide unit 151 acquires a guide image 143 that is obtained by superimposing a display item including the first to fourth indexes on the captured image SG (step S19). Then, the imaging guide unit 151 displays the guide image 143 on the screen display unit 130 (step S20).

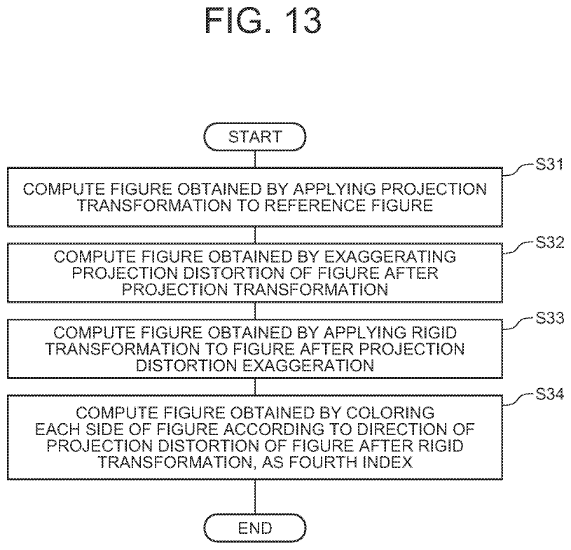

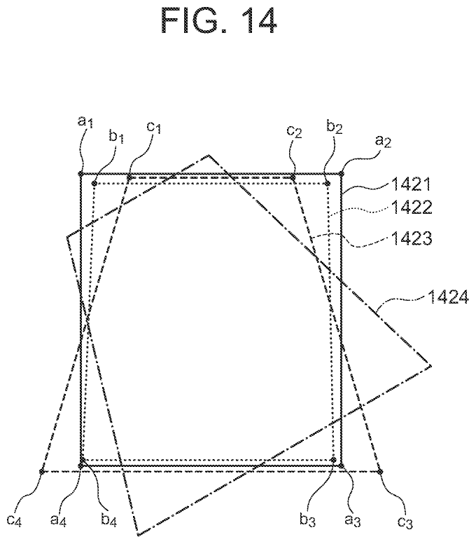

FIG. 13 is a flowchart illustrating an example of a process of computing the fourth index 1434. Referring to FIG. 13, the imaging guide unit 151 first computes a figure obtained by applying projection transformation to the reference FIG. 1421 by using the plane projection transformation matrix Mh′ computed at step S13 (step S31). FIG. 14 illustrates the reference FIG. 1421 and a FIG. 1422 obtained by applying projection transformation to it. The reference FIG. 1421 is a square having vertexes a₁, a₂, a₃, and a₄. The FIG. 1422 after the projection transformation is a trapezoid having vertexes b₁, b₂, b₃, and b₄.

Then, the imaging guide unit 151 computes a figure in which projection distortion of the FIG. 1422 after the projection transformation computed at step S31 is exaggerated (step S32). The FIG. 1423 illustrated in FIG. 14 is an example of a figure in which the projection distortion of the FIG. 1422 is exaggerated. The imaging guide unit 151 computes the figure in which the projection distortion is exaggerated by using a method as described below, for example.

First, for each vertex bₙ of the FIG. 1422, the imaging guide unit 151 computes a difference in the X coordinate values (bₙX−aₙX) and a difference in the Y coordinate values (bₙY−aₙY) between it and the corresponding vertex aₙ of the reference FIG. 1421. Then, the imaging guide unit 151 multiplies the difference by e. Here, e is a predetermined exaggeration coefficient. Then, the imaging guide unit 151 adds the value obtained by multiplying the difference by e to the coordinate value of the corresponding vertex aₙ of the reference FIG. 1421 to compute the coordinate values of vertexes c₁, c₂, c₃, and c₄ of the FIG. 1423 having the exaggerated projection distortion. The X coordinate value and the Y coordinate value of the vertex cₙ is given by the following expressions:

$${c}_{n} X = ( {b}_{n} X - {a}_{n} X ) \times e + {a}_{n} X \qquad ( 1 )$$

$${c}_{n} Y = ( {b}_{n} Y - {a}_{n} Y ) \times e + {a}_{n} Y \qquad ( 2 )$$

Referring to FIG. 13 again, the imaging guide unit 151 computes a figure obtained by applying transformation based on the rigid transformation matrix Mr, computed at step S11, to the FIG. 1423 in which the projection distortion is exaggerated computed at step S32 (step S33). A FIG. 1424 illustrated in FIG. 14 is an example of a figure obtained by applying the transformation to the FIG. 1423. Note that at step S33, the imaging guide unit 151 may compute the FIG. 1424 obtained by applying only the rotation component of the rigid transformation matrix Mr to the FIG. 1423.

Then, the imaging guide unit 151 computes a figure obtained by coloring each side of the FIG. 1424, computed at step 33, according to the projection distortion, as the fourth index 1434 (step S34).

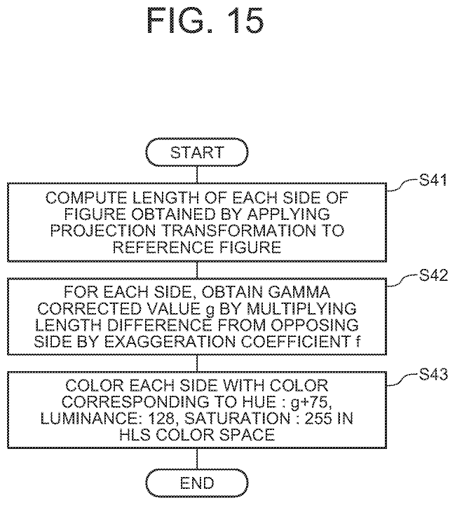

FIG. 15 is a flowchart illustrating an example of a process of coloring each side of a figure according to projection distortion. Referring to FIG. 15, the imaging guide unit 151 first computes the length of each of the sides h₁, h₂, h₃, and h₄ of the FIG. 1422 obtained by applying projection transformation to the reference FIG. 1421 by using the following expression (step S41):

$${h}_{n} = S Q R T ( {( {b}_{n} X - {b}_{n + 1} X )}^{2} + {( {b}_{n} Y - {b}_{n + 1} Y )}^{2} ) \qquad ( 3 )$$

Then, for each of the sides h₁, h₂, h₃, and h₄, the imaging guide unit 151 multiplies the difference in the length from the opposing side by an exaggeration coefficient f to obtain a gamma-corrected value gₙ (step S42).

$${g}_{n} = {( ( {h}_{{n}^{-}} {h}_{n + 2} ) \times f / 255 )}^{1 / gamma} \times 255 \qquad ( 4 )$$

Then, for each side of the FIG. 1424 corresponding to each side of the FIG. 1422 one to one, the imaging guide unit 151 colors the side with a color corresponding to hue: gₙ+75, luminance: 128, and saturation: 255 in the HLS color space (step S43). Here, the value range of the hue, luminance, and saturation is between 0 and 255. The color whose hue is 75 is green. When the hue becomes smaller than 75, the color becomes red, and when it becomes larger, the color becomes blue. From the above expression, a side having the same length as the opposing side is colored with green, a side shorter than the opposing side is colored with red, and a side longer than the opposing side is colored with blue.

The operation in the adjustment phase of the individual identification device 100 is as described above.

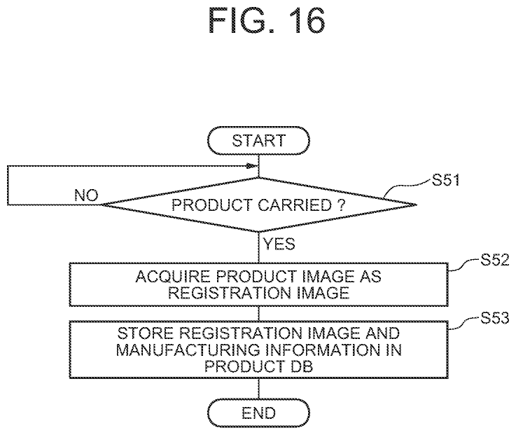

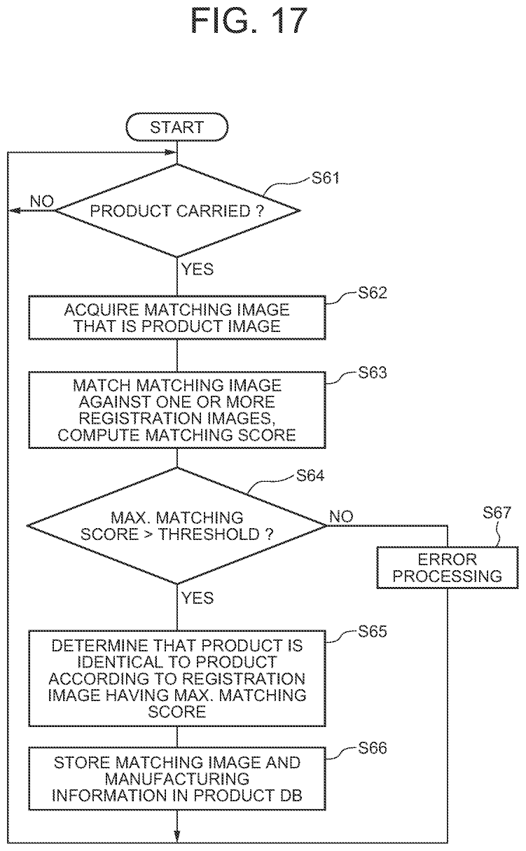

Next, operation in the operation phase of the individual identification device 100 will be described. FIG. 16 is a flowchart illustrating an example of operation of the registration unit 152 in the operation phase of the individual identification device 100. Further, FIG. 17 is a flowchart illustrating an example of operation of the matching unit 153 in the operation phase of the individual identification device 100.

First, operation of the registration unit 152 in the operation phase of the individual identification device 100 will be described with reference to FIG. 16. In the operation phase, when a product is carried into the first step processing device 201, it is detected by a sensor, not illustrated, provided in the first step processing device 201, and at the point of time when the product reaches a predetermined position, conveyance is temporarily stopped and the product is in a stationary state. Further, the fact that the product has been carried into the first step processing device 201 is notified from the first step processing device 201 to the individual identification device 100 via communication. When the registration unit 152 detects that the product has been carried in by the communication (YES at step S51), the registration unit 152 acquires an image of the product as a registration image (step S52). Then, the registration unit 152 stores the registration image and the manufacturing information of the product acquired from the first step processing device 201 in the product DB 144 of the storage unit 140 (step S53). The above-described operation is repeated each time a product is carried into the first step processing device 201.

Next, operation of the matching unit 153 in the operation phase will be described. When a product is carried into the second step processing device 202 by the conveying machine 204, it is detected by a sensor, not illustrated, provided in the second step processing device 202, and at the point of time when the product reaches a predetermined position, conveyance is temporarily stopped and the product is in a stationary state. Further, the fact that the product has been carried into the second step processing device 202 is notified from the second step processing device 202 to the individual identification device 100 via communication. When the matching unit 153 detects that the product has been carried in (step S61), the matching unit 153 acquires an image of the product as a matching image (step S52). Then, the matching unit 153 performs matching between the matching image and one or more registration images stored in the product DB 144, and computes the matching score (step S63). Here, as one or more registration images to be matched against the matching image, the matching unit 153 uses registration images in which matching against the matching image of the second step processing device has not succeeded, among the registration images registered in the product DB 144. For example, when the product DB 144 is in the state illustrated in FIG. 9 at the point of time of matching of the matching image, since matching between a registration image G101 and a matching image G201 has succeeded, matching is performed sequentially on registration images G102 to G108 in which matching has not succeeded.

When there is a registration image whose matching score with the matching image is larger than a threshold (YES at step S64), the matching unit 153 determines that the product of the matching image is identical to the product of the registration image whose matching score is larger than the threshold (step S65). In that case, the matching unit 153 stores the matching image and the manufacturing information acquired from the second step processing device 202 in the product DB 144 in association with the matched registration image (step S66). Then, the matching unit 153 returns to step S61 and repeats the same processing as that described above.

On the other hand, when there is no registration image whose matching score against the matching image is larger than the threshold in the product DB 144 (NO at step S64), the matching unit 153 performs error processing (step S67), and then returns to step S61 and repeats the same processing as that described above.

Next, the details of step S63 performed by the matching unit 153 will be described.

Various specific methods can be considered for matching between a matching image and a registration image by the matching unit 153. For example, the matching unit 153 may compare two images themselves with each other, or compare feature values obtained by applying any transformation to two images with each other. For example, the matching unit 153 may compare frequency spectrum images, obtained by applying frequency transform such as Fourier transform to the two images, with each other. Alternatively, the matching unit 153 may first apply frequency transform such as Fourier transform to the two images to transform them into frequency spectrum images respectively, and then, compare polar coordinate images (Fourier Mellin feature images) obtained by applying polar coordinate transformation or logarithm polar coordinate transformation to the frequency spectrum images. Alternatively, the matching unit 153 may apply frequency transform such as Fourier transform to two images to transform them into frequency spectrum images respectively, and then, apply polar coordinate transformation or logarithm polar coordinate transformation to the frequency spectrum images to transform them into Fourier Mellin features, and further apply frequency transform such as Fourier transform to the Fourier Mellin features and compare phase images obtained therefrom with each other. Hereinafter, an example of a matching method performed by the matching unit 153 will be described.

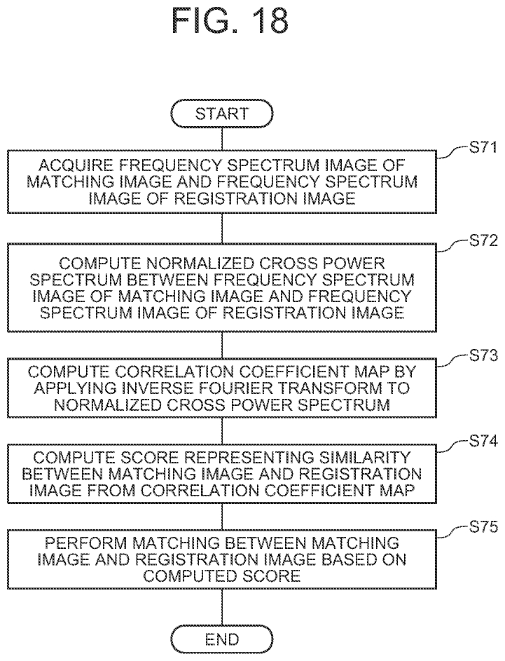

FIG. 18 is a flowchart illustrating an example of a process of matching between a matching image and a registration image by the matching unit 153. Referring to FIG. 18, first, the matching unit 153 performs discrete Fourier transform on the matching image and the registration image to acquire a frequency spectrum image of the matching image and a frequency spectrum image of the registration image (step S71). When there are a plurality of registration images, the matching unit 153 acquires a frequency spectrum image from each of the registration images. Then, for each of the registration images, the matching unit 153 computes a normalized cross power spectrum of the frequency spectrum image of the matching image and the frequency spectrum image of the registration image (step S72). Then, for each of the registration images, the matching unit 153 performs inverse Fourier transform on the normalized cross power spectrum to compute a correlation coefficient map (step S73). Then, for each of the registration images, the matching unit 153 computes a matching score representing the similarity between the matching image and the registration image from the correlation coefficient map (step S74). Then, on the basis of the matching score computed for each of the registration images, the matching unit 153 performs matching between the matching image and the registration image (step S75). For example, when the best score among the matching scores computed for the respective registration images is equal to or larger than a predetermined threshold, the matching unit 153 determines that the matching image coincides with (is identical to) the registration image having the best score. On the other hand, when the best score is less than the threshold, the matching unit 153 determines that the matching image does not coincide with (is not identical to) any of the registration images.

As described above, in the operation phase, the registration image of the product carried into the first step processing device 201 and the matching image of the product carried into the second step processing device 202 are acquired and applied with matching under the cameras 211 and 212 whose position and posture are adjusted in the adjustment phase, whereby identification of the individual product is performed.

As described above, according to the present embodiment, a user can easily determine how to adjust the direction the camera 212 to coincide with the direction of the camera 211 for registration, from the direction of the projection distortion of the figure constituting the fourth index 1434 shown on the guide image 143.

Moreover, in the present embodiment, the projection distortion of the figure constituting the fourth index 1434 is exaggerated. Therefore, even in the case where the posture difference is equal to or less than 10 degrees that is difficult to confirm the projection distortion by the naked eye, the user can easily confirm the direction of the projection distortion of the figure by the naked eye. As a result, the adjustment direction of the direction of the camera 212 can be easily recognized by the naked eye.

Moreover, in the present embodiment, each side of a figure constituting the fourth index 1434 is colored according to the direction of the projection distortion. Therefore, the user can visually confirm the direction of the projection distortion of the figure easily. As a result, the method of adjusting the direction of the camera 212 can be visually recognized easily.

In the case of exaggerating the displacement between images in order to improve the visibility of a difference between two images, when the entire displacement is simply exaggerated, not only projection distortion but also rotation distortion is exaggerated. However, when the rotation distortion is exaggerated, it becomes difficult to recognize the direction that the camera should be corrected. In view of the above, in the present embodiment, although projection distortion of the figure constituting the fourth index 1434 is exaggerated, rotation distortion of the figure is not exaggerated.

Further, according to the present embodiment, the user can recognize the positional shift and the rotational shift of the camera 212 with respect to the camera 211, according to the position and the direction of the square constituting the first index 1431 shown on the guide image 143.

Further, according to the present embodiment, the user can recognize the positional shift and the rotational shift of the camera 212 with respect to the camera 211, according to the length and the direction of the arrow constituting the second index 1432 shown on the guide image 143.

Further, according to the present embodiment, the user can recognize the amount of positional shift in the X-axis direction and the Y-axis direction of the camera 212 with respect to the camera 211, and the rotation angle of the camera 212 with respect to the camera 211, according to the text constituting the third index 1433 shown on the guide image 143.

### Second Example Embodiment

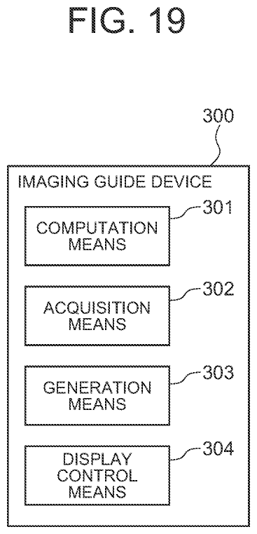

Next, an imaging guide device according to a second example embodiment of the present invention will be described with reference to FIG. 19. FIG. 19 is a block diagram of an imaging guide device according to the present embodiment.

Referring to FIG. 19, an imaging guide device 300 according to the present embodiment is configured to include a computation means 301, an acquisition means 302, a generation means 303, and a display control means 304.

The computation means 301 is configured to compute a plane projection transformation matrix of a first image obtained by capturing a flat surface of an object with a first imaging device and a second image obtained by capturing the flat surface with a second imaging device.

The acquisition means 302 is configured to acquire a second figure that is obtained by transforming a first figure that is virtually drawn in the first image in a predetermined direction and in a predetermined shape, on the basis of the plane projection transformation matrix.

The generation means 303 is configured to generate a tilt index representing a tilt in the imaging direction of the second imaging device with respect to the first imaging device on the basis of the second figure, and a display item including the tilt index.

The display control means 304 is configured to display the display item while superimposing it on the second image.

An imaging guide device 300 configured as described above operates as described below. First, the computation means 301 computes a plane projection transformation matrix of a first image obtained by capturing a flat surface of an object with a first imaging device and a second image obtained by capturing the flat surface with a second imaging device. Then, the acquisition means 302 acquires a second figure that is obtained by transforming a first figure that is virtually drawn in the first image in a predetermined direction and in a predetermined shape, on the basis of the plane projection transformation matrix. Then, the generation means 303 generates a tilt index representing a tilt in the imaging direction of the second imaging device with respect to the first imaging device on the basis of the second figure, and a display item including the tilt index. Then, the display control means 304 displays the display item while superimposing it on the second image.

According to the imaging guide device 300 that is configured and operates as described above, a user can easily determine the adjusting direction of the second imaging device so as to coincide with the direction of the first imaging device, from the direction of the projection distortion of the figure constituting the tilt index.

While the present invention has been described with reference to the exemplary embodiments described above, the present invention is not limited to the above-described embodiments. The form and details of the present invention can be changed within the scope of the present invention in various manners that can be understood by those skilled in the art.

For example in the first example embodiment, the present invention is applied to an imaging guide device for assisting the work to allow the position and the posture of the camera 212, set on s production line, to conform to the position and the posture of the camera 211. However, the present invention may be applied to an imaging guide device for the position and the posture of a camera for performing individual identification and authenticity discrimination by matching an image of a product captured by a user with a camera against an image of the product captured and registered in advance.

### INDUSTRIAL APPLICABILITY

The present invention is applicable to the field of identifying individuals. For example, the present invention is applicable to the field of identifying individuals of products flowing on a production line.

The whole or part of the example embodiments disclosed above can be described as, but not limited to, the following supplementary notes.

### (Supplementary Note 1)

An imaging guide device comprising:
computation means for computing a plane projection transformation matrix of a first image and a second image, the first image being obtained by capturing a flat surface of an object with a first imaging device, the second image being obtained by capturing the flat surface with a second imaging device;
acquisition means for acquiring a second figure that is obtained by transforming a first figure on a basis of the plane projection transformation matrix, the first figure being virtually drawn on the first image in a predetermined direction and in a predetermined shape;
generation means for generating a tilt index representing a tilt in an imaging direction of the second imaging device with respect to the first imaging device on a basis of the second figure, and generating a display item including the tilt index; and
display control means for displaying the display item in a superimposed manner on the second image.

### (Supplementary Note 2)

The imaging guide device according to claim 1, wherein
the computation means computes a rigid transformation matrix of the first image and the second image, and computes a plane projection transformation matrix of the first image and an image obtained by transforming the second image on a basis of the rigid transformation matrix.

### (Supplementary Note 3)

The imaging guide device according to supplementary note 1 or 2, wherein
the generation means generates a figure obtained by exaggerating projection distortion of the second figure as the tilt index.

### (Supplementary Note 4)

The imaging guide device according to any of supplementary notes 1 to 3, wherein
the first figure is a square, and
for each of four sides of the second figure, the generation means compares a length of a side with a length of an opposing side, and generates, as the tilt index, a figure obtained by coloring a side having a length that is same as a length of an opposing side with a first color, coloring a side having a length that is shorter than a length of an opposing side with a second color, and coloring a side having a length that is longer than a length of an opposing side with a third color.

### (Supplementary Note 5)

The imaging guide device according to supplementary note 2, wherein
the acquisition means further acquires a third figure that is obtained by transforming the first figure on a basis of the rigid transformation matrix, and
the generation means generates the display item that further includes the third figure as a non-tilt index.

### (Supplementary Note 6)

The imaging guide device according to supplementary note 5, wherein
the acquisition means further acquires an amount of a rotational shift and an amount of a positional shift of the third figure with respect to the first figure, and
the generation means generates the display item that further includes an arrow index representing the amount of the rotational shift and the amount of the positional shift by a direction and a length of an arrow.

### (Supplementary Note 7)

The imaging guide device according to supplementary note 6, wherein
the generation means generates the display item that further includes a text index representing the amount of the rotational shift and the amount of the positional shift in text.

### (Supplementary Note 8)

An imaging guide method comprising:
computing a plane projection transformation matrix of a first image and a second image, the first image being obtained by capturing a flat surface of an object with a first imaging device, the second image being obtained by capturing the flat surface with a second imaging device;
acquiring a second figure that is obtained by transforming a first figure on a basis of the plane projection transformation matrix, the first figure being virtually drawn on the first image in a predetermined direction and in a predetermined shape;
generating a tilt index representing a tilt in an imaging direction of the second imaging device with respect to the first imaging device on a basis of the second figure, and generating a display item including the tilt index; and
displaying the display item in a superimposed manner on the second image.

### (Supplementary Note 9)

A computer-readable medium storing thereon a program for causing a computer to execute processing to
compute a plane projection transformation matrix of a first image and a second image, the first image being obtained by capturing a flat surface of an object with a first imaging device, the second image being obtained by capturing the flat surface with a second imaging device;
acquire a second figure that is obtained by transforming a first figure on a basis of the plane projection transformation matrix, the first figure being virtually drawn on the first image in a predetermined direction and in a predetermined shape;
generate a tilt index representing a tilt in an imaging direction of the second imaging device with respect to the first imaging device on a basis of the second figure, and generating a display item including the tilt index; and
display the display item in a superimposed manner on the second image.

### REFERENCE SIGNS LIST

10 individual identification system
100 individual identification device
110 communication I/F unit
120 operation input unit
130 screen display unit
140 storage unit
141 program
142 reference image
143 guide image
144 product DB
150 arithmetic processing unit
151 imaging guide unit
152 registration unit
153 matching unit
201 first step processing device
202 second step processing device
203-205 conveying machine
211, 212 camera
221, 222 camera position/posture adjuster
231, 232 illumination unit
241, 242 product

What is claimed is:

1. An imaging guide device comprising:
a memory containing program instructions; and
a processor coupled to the memory, wherein the processor is configured to execute the program instructions to:
compute a plane projection transformation matrix of a first image and a second image, the first image being obtained by capturing a flat surface of an object with a first imaging device, the second image being obtained by capturing the flat surface with a second imaging device;
acquire a second figure that is obtained by transforming a first figure on a basis of the plane projection transformation matrix, the first figure being virtually drawn on the first image in a predetermined direction and in a predetermined shape;
generate a tilt index representing a tilt in an imaging direction of the second imaging device with respect to the first imaging device on a basis of the second figure, and generating a display item including the tilt index; and
display the display item in a superimposed manner on the second image.

2. The imaging guide device according to claim 1, wherein the processor is further configured to execute the instructions to,
in the computing the plane projection transformation matrix, compute a rigid transformation matrix of the first image and the second image, and compute a plane projection transformation matrix of the first image and an image obtained by transforming the second image on a basis of the rigid transformation matrix.

3. The imaging guide device according to claim 1, wherein the processor is further configured to execute the instructions to,
in the generating the tilt index, generate a figure obtained by exaggerating projection distortion of the second figure as the tilt index.

4. The imaging guide device according to claim 1, wherein
the first figure is a square, and
the processor is further configured to execute the instructions to,
in the generating the tilt index, for each of four sides of the second figure, compare a length of a side with a length of an opposing side, and generate, as the tilt index, a figure obtained by coloring a side having a length that is same as a length of an opposing side with a first color, coloring a side having a length that is shorter than a length of an opposing side with a second color, and coloring a side having a length that is longer than a length of an opposing side with a third color.

5. The imaging guide device according to claim 2, wherein the processor is further configured to execute the instructions to:
acquire a third figure that is obtained by transforming the first figure on a basis of the rigid transformation matrix; and
in the generating the display item, generate the display item that further includes the third figure as a non-tilt index.

6. The imaging guide device according to claim 5, wherein the processor is further configured to execute the instructions to:
acquire an amount of a rotational shift and an amount of a positional shift of the third figure with respect to the first figure; and
in the generating the display item, generate the display item that further includes an arrow index representing the amount of the rotational shift and the amount of the positional shift by a direction and a length of an arrow.

7. The imaging guide device according to claim 6, wherein the processor is further configured to execute the instructions to,
in the generating the display item, generate the display item that further includes a text index representing the amount of the rotational shift and the amount of the positional shift in text.

8. An imaging guide method comprising:
computing a plane projection transformation matrix of a first image and a second image, the first image being obtained by capturing a flat surface of an object with a first imaging device, the second image being obtained by capturing the flat surface with a second imaging device;
acquiring a second figure that is obtained by transforming a first figure on a basis of the plane projection transformation matrix, the first figure being virtually drawn on the first image in a predetermined direction and in a predetermined shape;
generating a tilt index representing a tilt in an imaging direction of the second imaging device with respect to the first imaging device on a basis of the second figure, and generating a display item including the tilt index; and
displaying the display item in a superimposed manner on the second image.

9. A non-transitory computer-readable medium storing thereon a program comprising instructions for causing a computer to execute processing to
compute a plane projection transformation matrix of a first image and a second image, the first image being obtained by capturing a flat surface of an object with a first imaging device, the second image being obtained by capturing the flat surface with a second imaging device;
acquire a second figure that is obtained by transforming a first figure on a basis of the plane projection transformation matrix, the first figure being virtually drawn on the first image in a predetermined direction and in a predetermined shape;
generate a tilt index representing a tilt in an imaging direction of the second imaging device with respect to the first imaging device on a basis of the second figure, and generating a display item including the tilt index; and
display the display item in a superimposed manner on the second image.
